(19) United States
(12) Patent Application Publication
(10) Pub. No.: US 2009/0233644 A1
(43) Pub. Date: Sep. 17, 2009

(54) MULTIPLE CARRIER RADIO SYSTEMS AND METHODS EMPLOYING POLAR ACTIVE ANTENNA ELEMENTS

(75) Inventor: Earl W. McCune, JR., Santa Clara, CA (US)

Correspondence Address: SNELL & WILMER L.L.P. (Panasonic), 600 ANTON BOULEVARD, SUITE 1400, COSTA MESA, CA, 92626, US

(73) Assignee: Matsushita Electric Industrial Co., Ltd.

(21) Appl. No.: 12/046,317

(22) Filed: Mar. 11, 2008

(51) Int. Cl. H04B 1/38; H04B 1/02

(52) U.S. Cl. 455/561; 455/102

(57) ABSTRACT

A multiple carrier radio system includes a baseband subsystem and a plurality of polar modulators. The polar modulators are mounted at antenna locations (e.g., in a base transceiver station (BTS)) above the ground), and are configured to receive modulation signals generated by the baseband subsystem. The plurality of polar modulators generates a plurality of modulated RF carrier signals using the modulation signals. The modulated RF carrier signals are radiated by a corresponding plurality of antenna elements coupled to the plurality of polar modulators.

### FIELD OF THE INVENTION

The present invention relates to wireless communications. More specifically, the present invention relates to the generation and transmission of multiple modulated radio frequency carrier signals in wireless communications networks.

### BACKGROUND OF THE INVENTION

A cellular communications network includes geographically dispersed base transceiver stations (BTSs) that provide an interface between cellular handsets and the network. To limit the number of BTSs that must be built and maintained in the network, the BTSs are equipped with radio systems that handle multiple calls at the same time. Traditionally, this has been accomplished by employing a multiple carrier BTS radio system 100 like that shown in FIG. 1. The multiple carrier BTS radio system 100 includes a plurality of transceivers (TX1, TX2, . . . , TX ) 102-1, 102-2 . . . 102-m (m is an integer that is ≧2), an associated plurality of linear power amplifiers (PAs) 104-1, 104-2, . . . , 104-m, a combiner 106 and an antenna 108. Modulation signals X₁, X₂, . . . , Xₘ are modulated onto the multiple radio frequency (RF) carrier signals generated by the plurality of transceivers 102-1, 102-2 . . . 102-m, and amplified by the associated plurality of linear PAs 104-1, 104-2, . . . , 104-m, thereby generating multiple modulated RF carrier signals. The multiple modulated RF carrier signals are combined by the combiner 106, to generate a single multi-carrier modulated RF carrier signal, which is coupled to the antenna 108 and finally radiated over the air to a remote receiver (e.g., a receiver of a cellular handset).

While the multiple carrier BTS radio system 100 does succeed in transmitting multiple modulated RF carrier signals at the same time, from a power consumption perspective it does so very inefficiently. The high inefficiency is attributable to the linear PAs 104-1, 104-2, . . . , 104-m and the combiner 106, typically a cavity type combiner, which dissipate large amounts of power. Together, the linear PAs 104-1, 104-2, . . . , 104-m and high-power combiner 106 limit the radio system 100 to an efficiency of only about 10%.

FIG. 2 is a diagram of an alternative BTS radio system 200, which avoids the use of a high-power combiner by combining the multiple carrier signals prior to being amplified. Similar to the BTS radio system 100 in FIG. 1, the multi-carrier BTS radio system 200 in FIG. 2 comprises a plurality of transceivers 202-1, 202-2 . . . 02-m that generates a plurality of modulated RF carrier signals. However, different from the multiple carrier radio system 100 in FIG. 1, the modulated RF carrier signals are combined before being amplified. Specifically, the combiner 204 combines the plurality of modulated RF carrier signals, thereby creating a single multi-carrier signal, which is amplified by a single multi-carrier power amplifier (MCPA) 206.

Because the modulated RF carrier signals in the multi-carrier radio system 200 in FIG. 2 are combined prior to being amplified, a high-power combiner is not required. Instead, a low power combiner 204 may be used. Unfortunately, the MCPA 206 is less efficient than the collective efficiency of the plurality of PAs 104-1, 104-2, . . . , 104-m in the multiple carrier BTS radio system 100 in FIG. 1. Consequently, very little efficiency gain is achieved over the multiple carrier BTS radio system 100 in FIG. 1, even though a low power combiner 204 can be used.

FIG. 3 is a drawing illustrating how an MCPA-based radio system 304, like the MCPA-based radio system 200 in FIG. 2, is configured within a BTS 300. The amplified multi-carrier signal at the output of the MCPA-based radio system 304 is conveyed to passive antenna elements 314 mounted on the BTS tower 310, via an RF antenna feed (typically a coaxial cable) 312. To limit intermodulation distortion products and thereby comply with air interface standards, the MCPA-based radio system 304 must operate with high linearity. Unfortunately, linear power amplifiers are very inefficient, and results in the MCPA-based radio system 304 being very large and heavy. In fact the MCPA-based radio system 304 is usually so large and heavy that it cannot, as a practical matter, be mounted in the BTS tower 310. Instead, it is housed within a cabinet 302 positioned on the ground near the base of the BTS tower 310. An air conditioning unit 308 is also typically included within the cabinet 302, to cool the MCPA-based radio system 304. The cabinet 302 protects the MCPA-based radio system 304 and the air conditioning unit 308 from the elements and from being vandalized.

While the multi-carrier BTS 300 in FIG. 3 does provide the ability to generate and transmit multiple modulated RF carrier signals, it has a number of significant shortcomings. First, the MCPA-based radio system 304 presents a single point of failure, since it only employs a single PA. Consequently, should the PA of the MCPA-based radio system 304 fail, the entire BTS 300 will fail. Second, the requirement that the MCPA-based radio system 304 operate with high linearity results in large amounts of wasted power. Not only is this wasted power costly, it is also harmful to the environment. Third, because the MCPA-based radio system 304 is so inefficient and must be mounted on the ground, power is lost in the antenna feed 312 as the amplified multi-carrier signal at the output of the MCPA-based radio system 304 is conveyed to the passive antenna elements 314 mounted in the BTS tower 310. This power loss can be substantial (8-15 dB, depending on the length of the antenna feed 312). Finally, due again to the inefficiency and size of the MCPA-based radio system 304, an expensive and power consuming air conditioning unit 308 is needed. When all of these inefficiencies are considered, the MCPA-based BTS 300 typically only operates with an overall efficiency between 1 to 5%.

Given the foregoing limitations and problems of prior art BTS radio systems, it would be desirable to have methods and systems for amplifying and transmitting multiple carrier signals that are efficient, inexpensive, do not require large air conditioning system, and are not subject to a single point of failure.

### BRIEF SUMMARY OF THE INVENTION

Multiple carrier radio systems and methods that employ polar active antenna elements (PAAE's) are disclosed. An exemplary multiple carrier radio system includes a baseband subsystem and a plurality of polar modulators. The polar modulators are mounted at antenna locations (e.g., in a base transceiver station (BTS)) above the ground), and are configured to receive modulation signals generated by the baseband subsystem. The plurality of polar modulators generates a plurality of modulated radio frequency (RF) carrier signals from the modulation signals. The modulated RF carrier signals are radiated by a corresponding plurality of antenna elements coupled to the plurality of polar modulators.

The multiple carrier radio systems and methods of the present invention have a number of significant advantages over prior art multi-carrier radio transmitter systems. First, the PAAE's employ nonlinear switch-mode PAs, rather than linear PAs. Consequently, the efficiency of the multiple carrier radio methods and systems of the present invention are substantially higher than prior art linear-PA-based approaches. Second, because the PAAE's used in the methods and systems of the present invention dissipate substantially less power compared to prior art linear-PA-based approaches, large air conditioning units and high power consuming AC/DC converters are not needed. Third, because RF power generation is performed up in the tower close to the antenna elements, and not on the ground as in prior art approaches, RF feed losses resulting from transferring RF power from the base of the BTS tower to the antenna elements are avoided. Fourth, because the systems and methods of the present invention use a plurality of PAs to generate multiple modulated RF carrier signals, the single point of failure problem caused by using only a single multi-carrier PA (MCPA) is avoided. Finally, but not necessarily lastly, high power consumption combiners are not needed to combine multiple RF carrier signals in the methods and systems of the present invention. Instead, in circumstances in which it is desired to combine RF carrier signals, the RF carrier signals are combined in space (i.e., spatially) after being radiated by the antennas of the PAAE's.

Further aspects of the invention are described and claimed below, and a further understanding of the nature and advantages of the invention may be realized by reference to the remaining portions of the specification and the attached drawings in which like reference numbers are used to indicate like or similar items.

### BRIEF DESCRIPTION OF THE DRAWINGS

FIG. 1 is a drawing of a traditional approach to generating a multi-carrier communications signal in a base transceiver station (BTS);

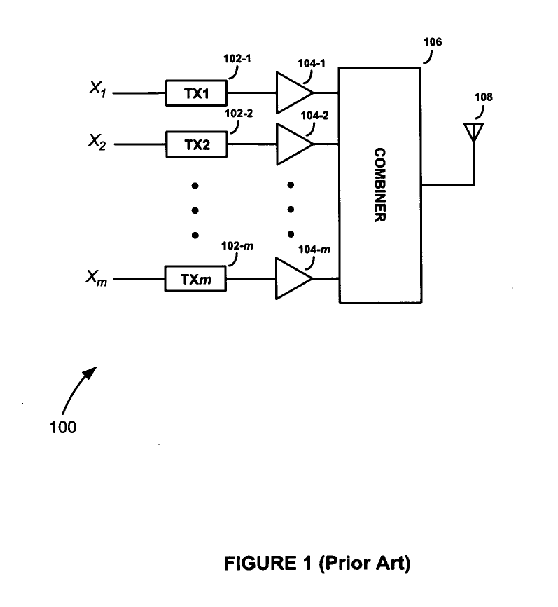

FIG. 2 is a drawing of a BTS radio system that utilizes a multi-carrier power amplifier (MCPA);

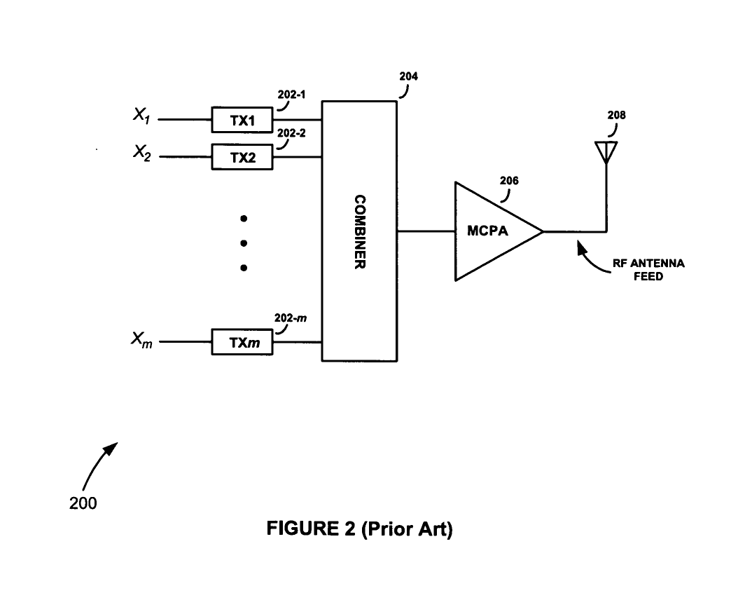

FIG. 3 is a drawing illustrating how a MCPA-based radio system is configured within a BTS;

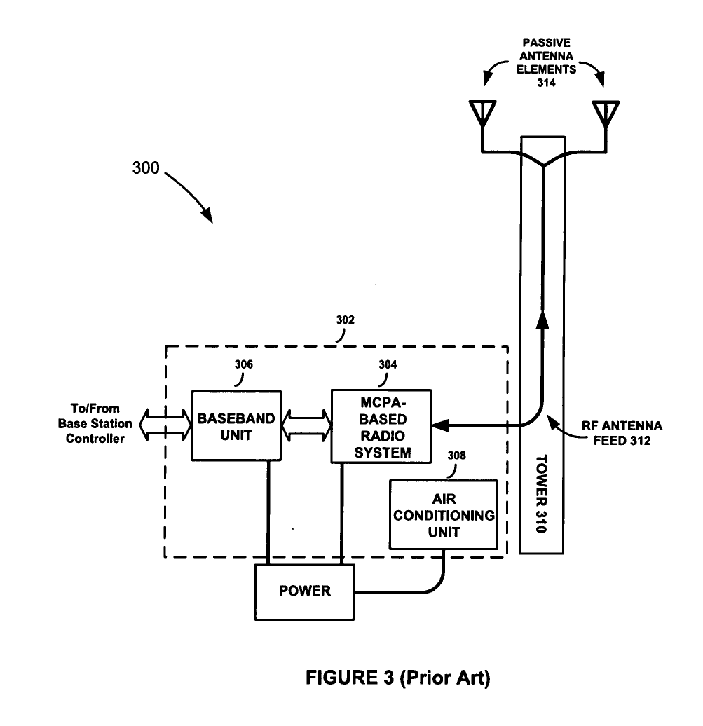

FIG. 4 is a drawing of a BTS equipped with polar active antenna elements (PAAE's), according to an embodiment of the present invention;

FIG. 5 is a drawing showing a PAAE, which may be used in the BTS in FIG. 4 or in the BTSs of other embodiments of the present invention;

FIG. 6 is a drawing of a multiple carrier radio transmitter system that employs a plurality of PAAE's, according to an embodiment of the present invention;

FIG. 7 is a drawing illustrating how a plurality of PAAE's may be configured in a polar active antenna array, according to an embodiment of the present invention; and

FIG. 8 is a conceptual drawing illustrating how multiple polar active antenna arrays may be mounted in a BTS tower, in accordance with embodiments of the present invention.

### DETAILED DESCRIPTION

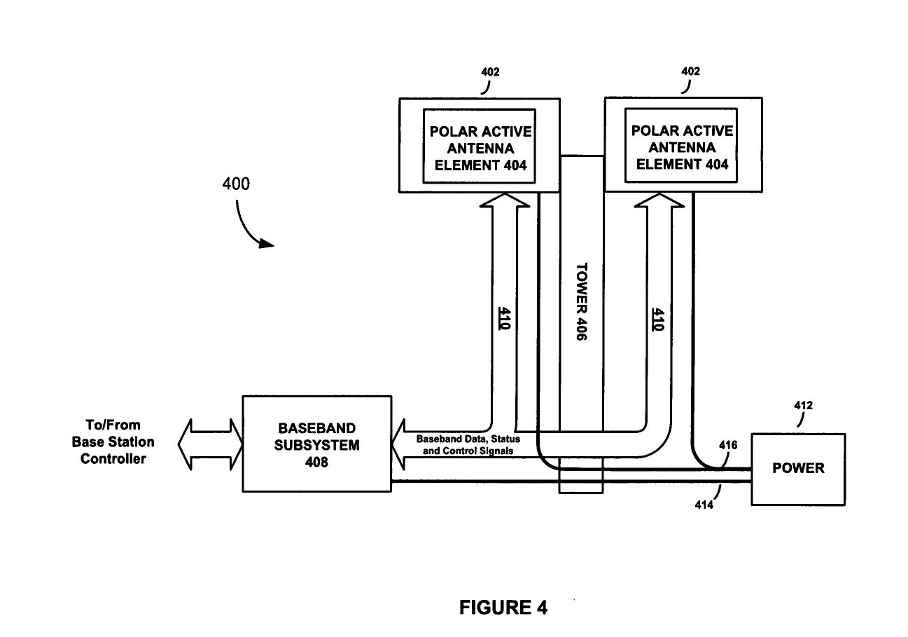

Referring to FIG. 4, there is shown a base transceiver station (BTS) 400 equipped with polar active antenna elements (PAAE's) 404, according to an embodiment of the present invention. The BTS 400 comprises a communications tower 406, upon which one or more radio frequency (RF) transceivers 402 having PAAE's 404 are mounted, and a baseband subsystem 408. A digital communications bus 410 comprising, for example, one or more fiber optic cables, is coupled between the RF transceivers 402 and the baseband subsystem 408 for conveying digital baseband data, status and control signals between the baseband subsystem 408 and the RF transceivers 402. A power source 412 provides power to the baseband subsystem 408 and to the RF transceivers 402 via power lines 414 and 416.

The baseband subsystem 408 of the BTS 400 is operable to send and receive digital messages to and from a base station controller (BSC) or mobile switching center. It may be placed in a cabinet or other protective housing at the base of the tower 406, mounted in the tower 406, or located at some other location. A digital message received by the baseband subsystem 408, and which is destined for transmission by one or more of the PAAE's 404, is first processed by a digital signal processor (DSP) within the baseband subsystem 408, to generate a digital baseband modulation signal. The digital baseband modulation signal is comprised of modulation symbols having modulation states defined by an applicable wireless communications standard, e.g., the Global System for Mobile Communications (GSM) standard, the Wideband Code Division Multiple Access (W-CDMA) standard, or other wireless communications standard.

According to one aspect of the invention, generating the digital baseband modulation signal includes converting the modulation symbols of the digital baseband modulation signal from rectangular (i.e., Cartesian) coordinates (x, y) to polar coordinates (ρ, θ), where ρ=\sqrt{x²+y²} and θ=arc tan(y/x). The resulting digital polar modulation signal is communicated over the communications bus 410 to the tower-mounted PAAE's 404. In an alternative embodiment, the Cartesian signal coordinates are communicated to the PAAE's 404 and the Cartesian-to-polar conversion is performed at each PAAE 404.

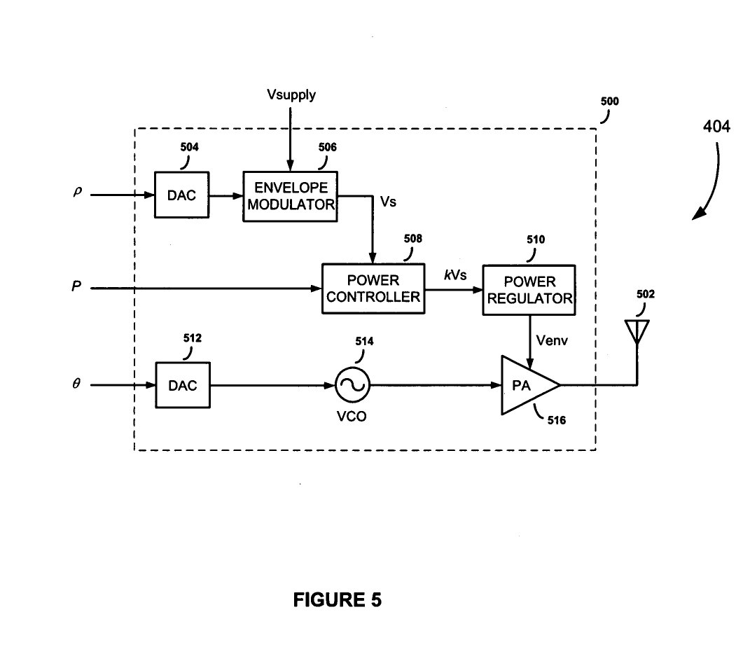

FIG. 5 is a drawing showing a PAAE 404 in more detail. The PAAE 404 comprises a polar modulator 500 and a dedicated antenna element 502. (The PAAE 404 may also include processing circuitry for converting Cartesian signal coordinates to polar coordinates, as was discussed in the previous paragraph.) The polar modulator 500 has an envelope path that includes a first digital-to-analog converter (DAC) 504, envelope modulator 506, power controller 508 and power regulator 510; a phase path that includes a second DAC 512 and a voltage controlled oscillator (VCO) 514; and a power amplifier (PA) 516. The first and second DACs 504 and 512 of the polar modulator 500 have digital inputs labeled “ρ” and “θ”, to indicate that they are to receive the digital envelope and phase components of digital baseband modulation signals, respectively, from the baseband subsystem 408. The power controller 508 has a power control signal input that is labeled “P”, to indicate that it is configured to receive a power control signal.

In the envelope path of the polar modulator 500, the first DAC 504 converts the digital envelope component of a digital baseband modulation signal into an analog baseband envelope modulation signal. The analog baseband envelope modulation signal is coupled to a first input of the envelope modulator 506, which operates to modulate a DC power supply voltage, Vsupply, according to amplitude variations in the analog baseband envelope modulation signal. The resulting amplitude modulated power supply signal, Vs, is coupled to the power controller 508, which may comprise, for example, a multiplying DAC. A power control signal generated by the baseband subsystem 408 and conveyed to the PAAE 404 via the digital communications bus 410, is applied to the power control signal input, P, and is used to control the output power of the PA 516. In other words, the power of the amplitude modulated power supply signal, Vs, from the envelope modulator 506 is scaled by a factor, k, by the power controller according to the digital power control signal, thereby providing a scaled amplitude modulated power supply signal, kVs. The scaled amplitude modulated power supply signal, kVs, is applied to the power regulator 510, which operates to generate an amplitude modulated power setting signal, Venv, for the modulator's PA 516. The PA 516 comprises a highly-efficient switch-mode PA that is driven repeatedly between a heavily compressed state (switch closed) and a cut-off state (switch open), in response to a constant-amplitude RF phase modulated signal generated in the phase path of the polar modulator 500 (discussed in more detail below). When driven into the heavily compressed state, the output power of the PA 516 is proportional to the square of the amplitude modulated power setting signal, Venv.

While the amplitude modulated power setting signal, Venv, is generated in the envelope path, a constant-amplitude RF phase modulated signal (i.e., an RF phase modulated signal having an amplitude that remains constant over time) is generated in the phase path. The constant-amplitude RF phase modulated signal is generated by first converting the phase component of the digital baseband modulation signal received from the baseband subsystem 408 into a constant-amplitude analog phase component signal, and then using the constant-amplitude analog phase component signal to phase modulate an RF carrier signal generated by the VCO 514. The resulting RF phase modulated signal is coupled to the RF input of the PA 516.

The amplitude modulated power setting signal, Venv, generated in the amplitude path of the polar modulator 500 and the RF phase modulated signal generated in the phase path of the polar modulator 500 are combined at the PA 516, thereby generating a fully modulated RF carrier signal. The fully modulated RF carrier signal is coupled to the antenna element 502, which radiates the fully modulated RF carrier signal to a remote receiver.

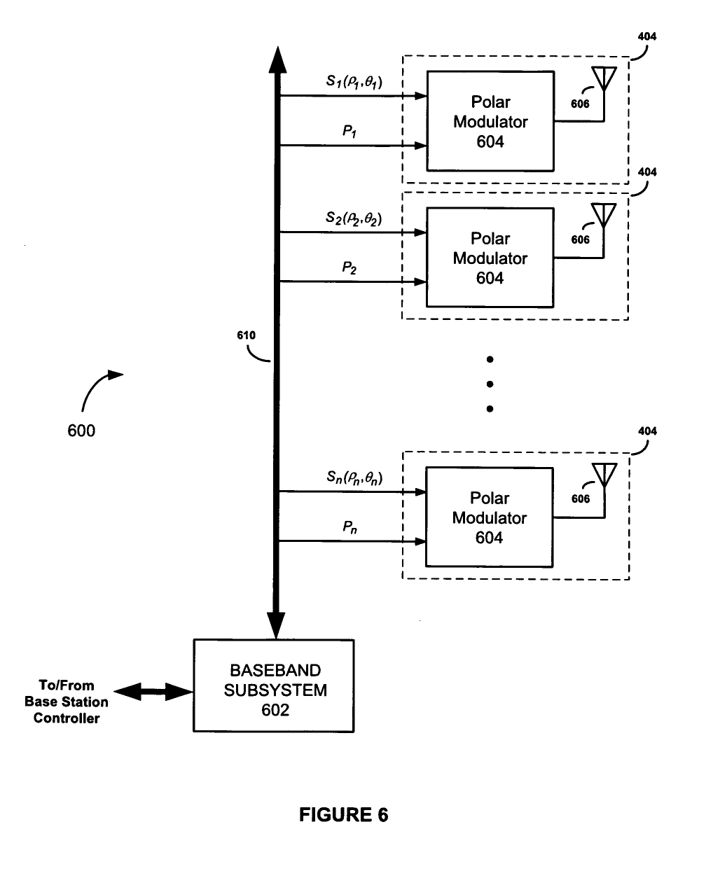

A plurality of PAAE's 404 may be configured to form a highly efficient multiple carrier radio system for a BTS of a cellular communications network. FIG. 6 is a drawing of an exemplary multiple carrier radio system 600 that employs multiple PAAE's 404, according to an embodiment of the present invention. The multiple carrier radio system 600 comprises a baseband subsystem 602 and a plurality of PAAE's 404. Each PAAE 404 contains a polar modulator 604 having a switch-mode PA, and an antenna element 606, similar to the polar modulator 500 shown in FIG. 5. The baseband subsystem 602 generates polar modulation signals S1 (ρ₁, θ₁), S2(ρ₂, θ₂), . . . , Sn(ρₙ, θₙ), where n is an integer that is ≧2. The polar modulation signals S1(ρ₁, θ₁), S2(ρ₂, θ₂), . . . , Sn(ρₙ, θₙ) are applied to the plurality of PAAE's 404, via a digital communication bus 610. Separate and independently controllable power control signals, P₁, P₂, . . . , Pₙ, which affect the individual output powers of the PAAE's 404, are also provided by the baseband subsystem 602 to the PAAE's 404, via the digital communications bus 610. The polar modulators 604 modulate the polar modulation signals S1(ρ₁, θ₁), S2(ρ₂, θ₂), . . . , Sn(ρₙ, θₙ) onto a plurality of RF carrier signals, which are then amplified by the individual switch-mode PAs of the polar modulators 604, to generate multiple modulated RF carrier signals. The multiple modulated RF carrier signals are coupled to the antenna elements 606, which radiate the multiple modulated RF carrier signals over the air to a remote receiver.

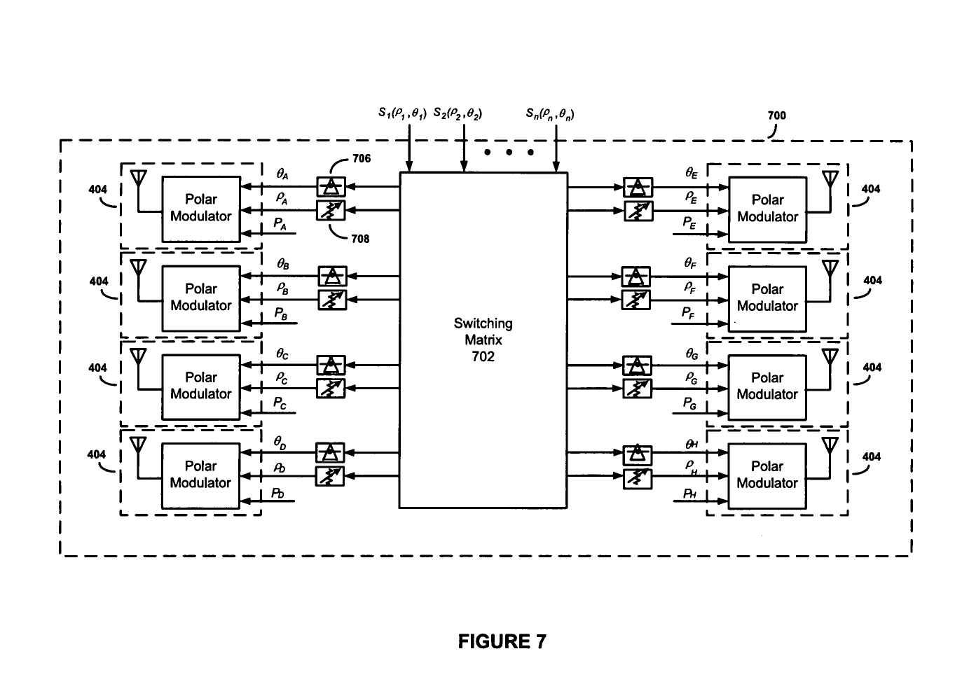

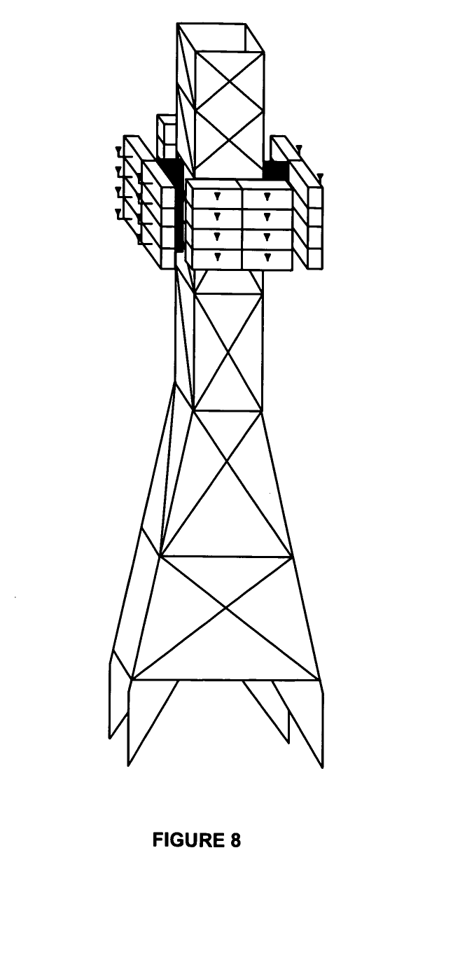

FIG. 7 is a drawing illustrating how a plurality of PAAE's 404 may be configured in a polar active antenna array 700, to amplify and transmit a plurality of modulate RF carrier signals, according to an embodiment of the present invention. A plurality of these polar active antenna arrays 700 may be mounted in a BTS tower to form a polar active phased array antenna system, as conceptually illustrated in FIG. 8. Each polar active antenna array 700 comprises a plurality of PAAE's 404 arranged in row-column array. Each PAAE 404 includes digital inputs configured to receive one of the digital polar modulation signals S1(ρ₁, θ₁), S2(ρ₂, ρ₂), . . . , Sn(ρₙ, θₙ) from a baseband subsystem (not shown in the drawing). In this exemplary embodiment, eight PAAE's 404 are included in the array 700. A different number may be used, as will be understood by those of ordinary skill in the art. Each active antenna element 404 has its own digital envelope and phase component inputs and its own independent power control input. Specifically, the digital envelope and phase component signal inputs and the power control inputs are labeled (ρ_{A}, θ_{A}, P_{A}), (ρ_{B}, θ_{B}, P_{B}), (ρ_{C}, θ_{C}, P_{C}) and (ρ_{D}, θ_{D}, P_{D}) for the PAAE's 404 in the first column of the array 700, and are labeled (ρ_{E}, θ_{E}, P_{E}), (ρ_{F}, θ_{F}, P_{F}), (ρ_{G}, ρ_{G}, P_{G}) and (ρ_{H}, θ_{H}, P_{H}) for the PAAE's 404 in the second column of the array 700. A switching matrix 702 disposed between the PAAE's 404 and the baseband subsystem operates to route each of the digital polar modulation signals, S1(ρ₁, θ₁), S2(ρ₂, θ₂), . . . , Sn(ρₙ, θₙ) to any one or more of the PAAE's 404, e.g., according to a predetermined routing algorithm used in a particular application.

According to one embodiment of the invention the power and/or phase relationships of the modulated RF signals radiated by the individual antenna elements of the plurality of PAAE's 404 are controlled to generate a spatially combined modulated RF carrier signal having a desired radiation pattern. Combining the individual modulated RF carrier signals from each PAAE 404 in space obviates any need for a conductive combiner. The output power of each PAAE 404, and therefore the radiation pattern of the spatially combined modulated RF signal, can be optimized by varying the power control signals applied to the power control inputs P_{A}, . . . , P_{H}. Further optimization of the radiation pattern of the spatially combined RF carrier signal, including its directionality, can be controlled by controlling the phase relationships among the digital polar modulation signals, S1(ρ₁, θ₁), S2(ρ₂, θ₂), . . . , Sn(ρₙ, θₙ), applied to the PAAE's 404. Phase-shift and amplitude calibration elements 706 and 708 coupled between the switching matrix 702 and each of the PAAE's 404 provide for this optimization capability. The phase shifts and amplitude calibrations may be performed dynamically during operation (e.g., in response to phase-shift and amplitude calibration signals provided by the baseband subsystem) or by manual adjustments made to the phase-shift and/or amplitude calibration elements 706 and 708 prior to system operation. The ability to independently calibrate the phase shifts and amplitude of the modulation signals applied to the PAAE's 404, together with the ability to independently control the power output of each PAAE 404 affords the ability to optimize the radiation pattern of the spatially combined modulated RF signal.

The present invention has been described with reference to specific exemplary embodiments. These exemplary embodiments are merely illustrative, and not meant to restrict the present invention. For example, while multiple PAAE's described in the embodiments above are suitable for amplifying and transmitting a plurality of carrier signals according to a single wireless communications standard, multiple PAAE's may also (or alternatively) be configured to amplify and transmit a plurality of carrier signals according to two or more different wireless communications standards. Further, while the various exemplary embodiments have been described in the context of cellular communications applications, those of ordinary skill in the art will appreciate and understand that the inventions disclosed and claimed herein are not necessarily limited to cellular communications applications. Hence, various changes, substitutions and alterations can be made without departing from the spirit and scope of the inventions as defined by the appended claims.

What is claimed is:

1. A radio transmitter system, comprising:
a baseband subsystem configured to generate modulation signals; and
a plurality of polar modulators configured to receive said modulation signals and generate a plurality of modulated RF carrier signals.

2. The radio transmitter system of claim 1 wherein each polar modulator of said plurality of polar modulators comprises:
a single carrier power amplifier; and
a dedicated antenna element coupled to an output of the single carrier power amplifier.

3. The radio transmitter system of claim 1 wherein each polar modulator of said plurality of polar modulators includes a power amplifier configured to operate as a nonlinear switch-mode power amplifier.

4. The radio transmitter system of claim 1 wherein an RF output power generated by any given polar modulator of said plurality of polar modulators is independently controllable.

5. The radio transmitter system of claim 1 wherein said plurality of polar modulators is configured in an array.

6. A base station for a communications network, comprising:
antenna locations;
a baseband subsystem configured to generate modulation signals;
a plurality of polar modulators mounted at said antenna locations; and
a communications bus configured to convey said modulation signals to said plurality of polar modulators.

7. The base station of claim 6 wherein said plurality of polar modulators are configured to:
generate multiple RF carrier signals; and
modulate said modulation signals onto said multiple RF carrier signals.

8. The base station of claim 6 wherein each polar modulator comprises:
a single carrier power amplifier; and
a dedicated antenna element coupled to an output of said single carrier power amplifier.

9. The base station of claim 6 wherein each polar modulator of said plurality of polar modulators includes a power amplifier configured to operates as a nonlinear switch-mode power amplifier.

10. The base station of claim 6 wherein an RF output power generated by any given polar modulator of said plurality of polar modulators is independently controllable.

11. The base station of claim 6 wherein said baseband subsystem and said plurality of polar modulators are configured to operate according to multiple wireless communications standards.

12. A method of generating modulated RF carrier signals, comprising:
communicating modulation signals to a plurality of polar modulators mounted at antenna locations;
modulating phase components of said modulation signals onto one or more RF carrier signals, to generate one or more phase modulated RF carrier signals;
amplifying and amplitude modulating said one or more phase modulated RF carrier signals, to generate one or more amplitude and phase modulated RF carrier signals;
coupling said one or more amplitude and phase modulated RF carrier signals to a plurality of antenna elements; and
radiating said one or more amplitude and phase modulated RF carrier signals over the air to a remote receiver.

13. The method of claim 12, further comprising independently controlling an RF output power generated by each polar modulator of said plurality of polar modulators.

14. The method of claim 12 wherein amplifying and amplitude modulating said one or more phase modulated RF carrier signals is performed by a plurality of nonlinear switch-mode power amplifiers of said plurality of polar modulators.

15. The method of claim 12 wherein communicating modulation signals to a plurality of polar modulators comprises communicating a plurality of modulation signals having modulation characteristics defined by two or more different wireless communications standards.

16. The method of claim 12 wherein said plurality of polar modulators and said plurality of antenna elements are arranged in one or more arrays.

17. The method of claim 16 wherein RF powers generated by the polar modulators in any given array are independently controllable.

18. The method of claim 12 wherein modulating phase components of said modulation signals onto one or more RF carrier signals comprises modulating phase components of said modulation signals onto a plurality of RF carrier signals, each RF carrier signal of said plurality of RF carrier signals generated by a single and separate polar modulator of said plurality of polar modulators.

19. A polar multiple carrier transmitter, comprising:
antenna locations;
means for generating polar modulation signals having phase components and amplitude components;
means for generating a plurality of carrier signals;
means for modulating the phase components of said polar modulation signals onto said plurality of RF carrier signals, to generate a plurality of phase modulated RF carrier signals;
means for amplifying the plurality of phase modulated RF carrier signals according to the amplitude components of said polar modulation signals, to generate a plurality of amplitude and phase modulated RF carrier signals; and
means for radiating the plurality of amplitude and phase modulated RF carrier signals over the air to a remote receiver,
wherein said means for modulating the phase components of said polar modulation signal onto said plurality of RF carrier signals and said means for amplifying the plurality of phase modulated RF carrier signals are mounted above the ground at said antenna locations.

20. The polar multiple carrier transmitter of claim 19 wherein said means for amplifying the plurality of phase modulated RF carrier signals comprises a plurality of power amplifiers configured to operate as nonlinear switch-mode power amplifiers.

21. The polar multiple carrier transmitter of claim 20 wherein the RF output power of each power amplifier is independently controllable.

22. The polar multiple carrier transmitter of claim 19 wherein said means for amplifying the plurality of phase modulated RF carrier signals comprises a plurality of single carrier power amplifiers, each single carrier power amplifier having a dedicated antenna element, and each single carrier power amplifier configured to amplify one of said plurality of phase modulated RF carrier signals.

23. The polar multiple carrier transmitter of claim 19 wherein said means for generating polar modulation signals comprises means for generating polar modulation signals having modulation characteristics defined by two or more wireless communications standards.

24. The polar multiple carrier transmitter of claim 19 wherein said means for radiating comprises a plurality of antenna elements of an antenna array.

25. The polar multiple carrier transmitter of claim 19, further comprising means for modifying a radiation pattern formed by a spatial combination of said radiated plurality of amplitude and phase modulated RF carrier signals.
